(19) United States
(12) Patent Application Publication
(10) Pub. No.: US 2024/0186574 A1
(43) Pub. Date: Jun. 6, 2024

(54) SOLID-STATE POLYMER ELECTROLYTE FOR LITHIUM BATTERY

(71) Applicant: NATIONAL CHENG KUNG UNIVERSITY, Tainan City (TW)

(72) Inventors: Hsisheng TENG, Tainan City (TW); Thi Tuyet Hanh NGUYEN, Tainan City (TW); Le Minh NGUYEN, Tainan City (TW); Wen-Hsiang WU, Tainan City (TW); Yu-hsing LIN, Tainan City (TW)

(21) Appl. No.: 18/528,829

(22) Filed: Dec. 5, 2023

Related U.S. Application Data
(60) Provisional application No. 63/430,388, filed on Dec. 6, 2022.

(51) Int. Cl. H01M 10/0565; H01M 4/62; H01M 10/052; H01M 10/0568

(52) U.S. Cl. CPC H01M 10/0565; H01M 4/624; H01M 10/052; H01M 10/0568; H01M 2300/0082; H01M 2300/0085

(57) ABSTRACT

A solid-state polymer electrolyte for lithium batteries is provided. The solid-state polymer electrolyte includes a solid-state network polymer electrolyte, formed by a modified poly(ethylene oxide) polymer material and an epoxy alkane crosslinking agent to form a poly(ethylene oxide) network structure, wherein the modified poly(ethylene oxide) high molecular weight material has an amino end, and the solid-state network polymer electrolyte comprises a lithium salt, The ratio of ethylene oxide (EO) to lithium (Li) in the solid-state network polymer electrolyte is 1:1 to 3:1, and a poly(vinylidene fluoride)-based polymer is doped in the solid-state network polymer electrolyte.

### CROSS-REFERENCE TO RELATED APPLICATIONS

The present application claims priority under 35 U.S.C. § 119(e) to U.S. Provisional Patent Application No. 63/430,388, filed on Dec. 6, 2022, the disclosure of which is herein incorporated by reference in its entirety.

### FIELD OF INVENTION

The present invention relates to solid-state polymer electrolytes for lithium batteries, and in particular to solid-state polymer electrolytes including a poly(ethylene oxide)-based network structure.

### BACKGROUND OF INVENTION

The demand for lithium-ion batteries (LIBs) has risen sharply from the widespread use of for portable electronics and electric vehicles. The high energy density of Li-metal anodes (˜3860 mAh g⁻¹) makes them an ideal replacement for graphite anodes (˜372 mAh g⁻¹). In efforts to realize high-energy Li-metal batteries (LMBs), solid electrolytes (SEs) have been developed as an alternative to liquid electrolytes (LEs) with the aim of minimizing the consumption of Li in forming a solid-electrolyte interface (SEI) and eliminating the risk of combustion.

Among SEs, advanced solid ceramic electrolytes (SCEs) provide high ionic conductivity (o) but excessive resistance at the contact with the electrodes, leading to energy loss.

LEs can improve the interfacial contact between SCEs and electrodes, however, increasing the risk of combustion.

In the conventional art, soft solid polymer electrolytes (SPEs) possessing high interfacial compatibility with electrodes have been developed. However, existing SPEs suffer from low σ.

Networking or crosslinking polymer chains to increase the amorphous domain is an effective approach to improving the σ of SPEs. However, the Li⁺-transference number (t_{Li+}) of ion conduction in SPEs is generally too low to deal with the strong attraction of high-polarity polymer chains to Li⁺. Low t_{Li+} results in polarization, which in turn leads to the non-uniform deposition of Li in the form of dendrites on the Li-anode surface.

Therefore, it is necessary to provide solid-state polymer electrolytes for lithium batteries to solve the problems existing in the conventional art.

### SUMMARY OF INVENTION

An aspect of the present invention is to provide solid-state polymer electrolytes for lithium batteries, which are composed of an interpenetrating polymer network electrolyte (IPNE) including incorporated polymer networks possessing enhanced ion-complex dissociating and Li⁺ transport regulating abilities and mechanical strength, are an ideal solution to conductivity and interface problems, and overcoming the challenges involved in applying SPEs to LMBs will require complementary polymer networks to produce IPNE as described herein.

Another aspect of the present invention is to provide solid-state polymer electrolytes for lithium batteries, which use epoxy alkane crosslinkers, such as polyhedral oligomeric silsesquioxane (POSS) to produce a polymeric network capable of promoting salt dissociation and facilitating ion transport, thereby improving ionic conductivity and the electrochemical performance of the resulting SPE.

Another aspect of the present invention is to provide solid-state polymer electrolytes for lithium batteries, which in the LiFSI-induced SEI on Li-anodes, the uniform distribution of LiF, Li₂CO₃, Li₂O, LiOH, and sulfur compounds tended to eliminate space charge accumulation, enhance Li⁺ migration, and reduce electron tunneling.

Yet another aspect of the present invention is to provide solid-state polymer electrolytes for lithium batteries, which FSI⁻ may aggregate to form a polymer-like ionic network capable of facilitating the migration of Li⁺.

One aspect of the solid-state polymer electrolytes for lithium batteries may include a solid-state network polymer electrolyte formed by a modified poly(ethylene oxide)-based polymer and an epoxy alkane crosslinker to form a poly(ethylene oxide)-based network structure, wherein the modified poly(ethylene oxide)-based polymer has an amino end, wherein the solid-state network polymer electrolyte includes a lithium salt, and a ratio of EO group to Li⁺ in the solid-state network polymer electrolyte ranges from 1:1 to 3:1, wherein the solid-state network polymer electrolyte is interpenetrated by a poly(vinylidene fluoride)-based polymer.

In one aspect of the solid-state polymer electrolytes, the epoxy alkane crosslinker selected at least one of siloxane, trimethylolpropane triglycidyl ether (TMPTGE), and polydimethylsiloxane dioxirane.

In one aspect of the solid-state polymer electrolytes, the poly(vinylidene fluoride)-based polymer includes a plurality of poly(vinylidene fluoride-co-hexafluoropropylene) (PVdF-HFP) chains, and the PVdF-HFP chains are cross-linked into a poly(vinylidene fluoride)-based network structure.

In one aspect of the solid-state polymer electrolytes, the poly(vinylidene fluoride)-based network structure is bridged via C—C coupling among the PVdF-HFP chains.

In one aspect of the solid-state polymer electrolytes, the lithium salt is lithium bis(fluorosulfonyl)imide (LiFSI), and the FSI⁻ anion aggregates in the poly(vinylidene fluoride)-based network structure to form a cluster.

In one aspect of the solid-state polymer electrolytes, the amino ends of the modified poly(ethylene oxide)-based polymer create an alkalescent environment capable of catalyzing defluorination/dehydrogenation and the subsequent crosslinking of PVdF-HFP chains to form an interpenetrating network structure.

In one aspect of the solid-state polymer electrolytes may further include a filler, wherein the filler is a lithium lanthanum zirconium oxide (LLZO) ceramic filler.

In one aspect of the solid-state polymer electrolytes may include a network structure formed by cross-linking polyhedral oligomeric silsesquioxane (POSS) with the modified poly(ethylene oxide)-based polymer.

Another aspect of the solid-state polymer electrolytes may include: an interpenetrating network structure, wherein the interpenetrating network structure includes a poly(ethylene oxide)-based network structure and a poly(vinylidene fluoride)-based network structure, wherein the poly(ethylene oxide)-based network structure is formed by a modified poly(ethylene oxide)-based polymer material and an epoxy alkane crosslinker, and the modified poly(ethylene oxide)-based polymer has an amino end, the poly(vinylidene fluoride)-based network structure is formed by cross-linking a plurality of poly(vinylidene fluoride-co-hexafluoropropylene) (PVdF-HFP) chains, and the poly(vinylidene fluoride)-based network structure has FSI⁻ anions aggregated to form FSI⁻ anionic clusters.

In one aspect of the solid-state polymer electrolytes, a ratio of EO group to Li⁺ in the interpenetrating network structure ranges from 1:1 to 3:1.

The beneficial effects of the present invention are:

An interpenetrating polymer network electrolyte (IPNE) including incorporated polymer networks possessing enhanced ion-complex dissociating and Li⁺ transport regulating abilities and mechanical strength is an ideal solution to conductivity and interface problems. Overcoming the challenges involved in applying SPEs to LMBs will require complementary polymer networks to produce IPNE as described herein. By using epoxy alkane crosslinkers, such as polyhedral oligomeric silsesquioxane (POSS) to produce a polymeric network capable of promoting salt dissociation and facilitating ion transport, thereby improving ionic conductivity and the electrochemical performance of the resulting SPE. In the LiFSI-induced SEI on Li-anodes, the uniform distribution of LiF, Li₂CO₃, Li₂O, LiOH, and sulfur compounds tended to eliminate space charge accumulation, enhance Li⁺ migration, and reduce electron tunneling.

The present invention is further combined with lithium bis(fluorosulfonyl)imide (LiFSI). The —CF₂—/—CF₃ segments of the poly(vinylidene fluoride)-based networked SPEs (F-NSPE) aggregate FSI⁻ to form connected Li⁺-diffusion domains, and —C—O—C— segments of the poly(ethylene oxide)-based networked SPEs (O-NSPE) dissociate the complexed ions to expedite Li⁺ transport. The synergy between O-NSPE and F-NSPE gives IPNE high ionic conductivity (˜1 mS cm⁻¹) and a high Li-transference number (˜0.7) at 30° C. FSI⁻ aggregation prevents the formation of a space-charge zone on the Li-anode surface to enable uniform Li deposition. In Li∥Li cells, the proposed IPNE exhibits an exchange current density exceeding that of liquid electrolytes (LEs). A Li|IPNE|LiFePO₄ ASSB achieves charge-discharge performance superior to that of LE-based batteries and delivers a high rate of 7 mA cm⁻². Exploiting the synergy between polymer networks to construct speedy Li⁺-transport pathways is a promising approach to the further development of SPEs. This electrolyte can be incorporated with ceramic or replaced with other cross-linkers to further improve their performance.

### DRAWINGS

FIG. 1 shows a structural schematic diagram of a solid-state polymer electrolyte according to an embodiment of the present invention.

FIG. 1a shows a schematic mechanism diagram of the self-crosslinking system of the present invention.

FIG. 2a shows the schematic diagram of the ion conductivity (o) of O-NSPE, F-NSPE, and FₓO-IPNE membranes at various temperatures within a range of 20-90° C.

FIG. 2b shows Li⁺ conductivities (σ_{Li+}, which is equal to σ×t_{Li+}) of O-NSPE, F-NSPE, and FₓO-IPNE membranes at 30° C.

FIG. 3 shows a schematic diagram of the electrochemical analysis results of F_{0.15}O-IPNE.

FIG. 4 shows the Fourier Transform Infrared (FTIR) spectra of the F_{0.15}O-IPNE precursor solution (the blended O-NSPE and F-NSPE in DMAc), the F_{0.15}O-IPNE, and salt LiFSI.

FIG. 4a shows a comparison of the focused spectra in FIG. 4 in the proximity of 1630 cm⁻¹.

FIG. 5a shows a schematic diagram of the results of differential scanning calorimetry (DSC) analysis of O-NSPE, F-NSPE, and F_{0.15}O-IPNE.

FIG. 5b shows a schematic diagram of the thermogravimetric analysis profiles of F_{0.15}O-IPNE.

FIG. 6 shows the schematic diagram of the mechanical strength analysis of the F-NSPE, O-NSPE, and F_{0.15}O-IPNE.

FIG. 6a shows a schematic diagram of the viscoelastic properties of the F_{0.15}O-IPNE membrane at 30° C.

FIG. 6b shows a schematic diagram of the Linear sweep voltammogram of the F_{0.15}O-IPNE assembled in Li∥SS cell.

FIGS. 7a to 7c show the Raman spectra of O-NSPE, F-NSPE, and F_{0.15}O-IPNE, respectively.

FIG. 8 shows a schematic diagram of the impedance spectrum of Li|F_{0.15}O-IPNE|Li battery for 7 days.

FIGS. 8a, 8b, 8c, and 8d respectively show schematic diagrams of cyclic Li plating/stripping in the Li|F_{0.15}O-IPNE|Li cell at 30° C., with each plating and stripping step performed at 0.5 mA cm⁻² for 1 h, in which FIG. 8a is a schematic diagram of the cell voltage versus time with the current density varied between 0.05 and 1.0 mA cm⁻²;

FIG. 8b shows the corresponding impedance spectra of the cell before initiating charge/discharge cycling at the current densities; FIG. 8c shows the voltage profiles of charge/discharge cycling for 300 h under a current density of 0.3 mA cm⁻² with a capacity of 0.3 mAh cm⁻²; and FIG. 8d shows the corresponding impedance spectra of the cell before and after cycling.

FIGS. 8e and 8f respectively show schematic diagrams of cyclic Li plating/stripping in the Li|F_{0.15}O-IPNE|Li cell at 30° C., with each plating and stripping step performed at 0.5 mA cm⁻² for 1 h; in which FIG. 8e shows the voltage profiles of charge/discharge cycling for 150 h, and FIG. 8f shows the corresponding impedance spectra of the cell, measured before and after cycling.

FIG. 9a shows a schematic diagram of the charge-discharge profile of Li|F_{0.15}O-IPNE|LiFePO₄ battery.

FIG. 9b shows a schematic diagram of the cycling performance of Li|F_{0.15}O-IPNE|LiFePO₄ and Li|LE|LiFePO₄ battery charged and discharged within 2.5-4.0 V at 1 C.

FIG. 9c shows an SEM image of the tight contact between the F_{0.15}O-IPNE and LiFePO₄ particles.

FIG. 9d shows a side-view and focused (inset) SEM images of the Li metal anode in the Li|F_{0.15}O-IPNE|LiFePO₄ cell.

FIG. 10a shows a schematic diagram of the impedance spectra of the Li|F_{0.15}O-IPNE|LiFePO₄ battery measured before and after 200 charge-discharge cycles.

FIG. 10b shows a schematic diagram of the charge-discharge profile of Li|F_{0.15}O-IPNE|LiFePO₄ battery.

FIG. 11a and FIG. 11b shows side-view SEM images of the Li metal anodes in the cycled Li| liquid electrolyte (LE)|LiFePO₄ batteries assembled using different Les, in which FIG. 11a uses 1-M LiPF₆@EDDV, and FIG. 11b uses 1-M LiPF₆@ED.

FIGS. 12a and 12b show schematic diagrams of the current-voltage curves of the batteries with different electrolytes.

FIG. 12c shows a schematic diagram of Tafel plots of the Li|Li cells with the various electrolytes.

FIG. 13a shows a schematic diagram of the cycling performance of Li|F_{0.15}O-IPNE|LiFePO₄ battery with high loading of active LiFePO₄ (10.6 mg cm⁻²).

FIG. 13b shows a schematic diagram of the corresponding charge-discharge profiles for Li|F_{0.15}O-IPNE|LiFePO₄.

FIG. 14 shows a schematic diagram of the ion conductivity comparison results of electrolytes with different EO:Li ratios.

FIG. 15 shows a schematic diagram of the promising pathways of Li⁺ transport in the F_{0.15}O-IPNE electrolyte.

### DETAILED DESCRIPTION OF EMBODIMENTS

The following are specific embodiments to illustrate the implementation methods of the present invention. Those skilled in the art can easily understand the spirit, advantages, and efficacy of the present invention based on the content disclosed in this specification. However, the specific embodiments of the present invention are not intended to limit the scope of the invention. The present invention may also be implemented or applied through other different embodiments. The details contained in this specification may also be subject to different changes or modifications based on different perspectives and applications, without departing from the spirit of the present invention.

The term “comprising/comprises” or “including/includes” components or steps used herein, unless otherwise specified, other components or steps may be included instead of excluding the said other components or steps. In addition, unless otherwise explicitly stated herein, the singular forms of “a” and “said/the” include plural indicators, and the use of “or” in this article is interchangeable with “and/or”.

The numerical ranges described herein are inclusive and combinable, and any numerical value falling within the numerical range described herein can be taken as a maximum or minimum value to derive a subrange; for example, a numerical range of 41° C., 53° C., 65° C. may derive a range of 41-53° C., 41-65° C., 53-65° C., and other sub-ranges; and, if a value falls within each range described herein (e.g., between the maximum and minimum values stated), it shall be deemed to be included in the present disclosure. In addition, the percentage symbol “%” mentioned herein represents weight percentage unless otherwise specified.

As used herein, the term “approximately/about” usually refers to values intended to include deviations of +20%, +10%, +5%, +1%, +0.5%, +0.1% within a given value or range. The numerical deviation may be caused by, for example, experimental errors; measurement standard deviations or processing procedures for preparing compounds, components, concentrates, and formulas, the source, manufacturing, purity of starting materials or components, and similar considerations. Alternatively, when considered by those skilled in the art, the term “approximately/about” means within an acceptable standard error of the mean. Unless explicitly specified, all numerical ranges, quantities, values, and ratios, such as the materials, duration of time periods, temperatures, execution conditions, proportions of content, and quantification of their analogs disclosed herein should be understood to be modified by the term “approximately/about” in all cases.

The present invention provides the solid-state polymer electrolytes for lithium batteries that may include a solid-state network polymer electrolyte formed by a modified poly(ethylene oxide)-based polymer and an epoxy alkane crosslinker to form a poly(ethylene oxide)-based network structure, wherein the modified poly(ethylene oxide)-based polymer has an amino end, and a poly(vinylidene fluoride)-based polymer interpenetrated in the solid-state network polymer electrolyte. Moreover, the solid-state network polymer electrolyte may include a lithium salt, and a ratio of ethylene oxide (EO) group to Li⁺ in the solid-state network polymer electrolyte ranges from 1:1 to 3:1.

The present invention also provides a solid-state polymer electrolyte for lithium batteries, including an interpenetrating network structure, wherein the interpenetrating network structure includes a poly(ethylene oxide)-based network structure and a poly(vinylidene fluoride)-based network structure, wherein the poly(ethylene oxide)-based network structure is formed by a modified poly(ethylene oxide)-based polymer material and an epoxy alkane crosslinker, and the modified poly(ethylene oxide)-based polymer has an amino end, the poly(vinylidene fluoride)-based network structure is formed by cross-linking a plurality of poly(vinylidene fluoride-co-hexafluoropropylene) (PVdF-HFP) chains, and the poly(vinylidene fluoride)-based network structure has FSI⁻ anions aggregated to form FSI⁻ anionic clusters.

The present invention develops an interpenetrating polymer network electrolyte (IPNE) including poly(ethylene oxide)- and poly(vinylidene fluoride)-based networked SPEs (poly(ethylene oxide)-based networked SPEs (O-NSPEs) and poly(vinylidene fluoride)-based networked SPEs (F-NSPEs), respectively) to address these challenges. The present invention further combines lithium bis(fluorosulfonyl) imide (LiFSI), the —CF₂—/—CF₃ segments of the F-NSPE aggregate FSI⁻ to form connected Lit-diffusion domains, and —C—O—C— segments of the O-NSPE dissociate the complexed ions to expedite Li⁺ transport. The synergy between O-NSPE and F-NSPE gives IPNE high ionic conductivity (˜1 mS cm⁻¹) and a high Li-transference number (˜0.7) at 30° C. FSI⁻ aggregation prevents the formation of a space-charge zone on the Li-anode surface to enable uniform Li deposition. In Li∥Li cells, the proposed IPNE exhibits an exchange current density exceeding that of liquid electrolytes (LEs). A Li|IPNE|LiFePO₄ ASSB achieves charge-discharge performance superior to that of LE-based batteries and delivers a high rate of 7 mA cm⁻². Exploiting the synergy between polymer networks to construct speedy Li⁺-transport pathways is a promising approach to the further development of SPEs. This electrolyte can be incorporated with ceramic or replaced with other cross-linkers to further improve their performance.

Therefore, alternatively, the solid-state network polymer electrolyte also includes a filler, wherein the filler is a lithium lanthanum zirconium oxide (LLZO) ceramic filler.

The following content will provide a detailed description of the operation, principles, and effects of the present invention using preferred embodiments as examples.

The amorphous phase in solid polymer electrolytes (SPEs), which allows swift agitation of the polymer chains, is the major domain involving the Li⁺-transport pathways. High lithium salt loading could substantially enlarge the amorphous zone of SPEs. However, the compromised salt-dissociating ability of the intertwined polymer chains would hinder the benefits of salt addition on σ.

Organosilicon-based functional compounds have attracted attention as an agent to segregate polymer chains in order to improve the performance of SPEs for lithium battery applications

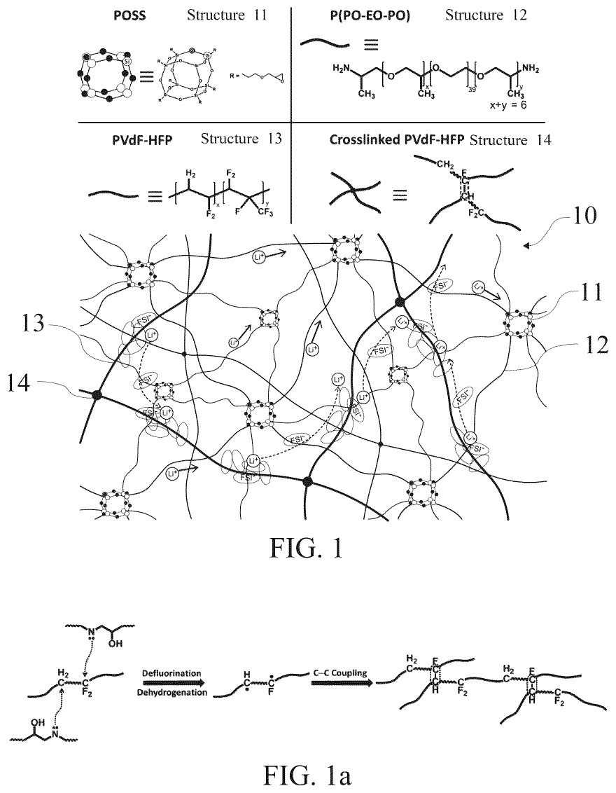

As shown in FIG. 1, the present invention illustrates the improvement efficiency of solid-state polymer electrolyte 10 in lithium battery applications through the structural composition of the embodiments. Structure 11 represents the addition of an epoxy alkane crosslinker (optional, the epoxy alkane crosslinker may be selected at least one of siloxane, trimethylolpropane triglycidyl ether (TMPTGE), and polydimethylsiloxane dioxirane). For example, polyhedral oligomeric silsesquioxane (POSS) is introduced into separators and electrolytes to enhance thermal stability. POSS is used as a crosslinker, including an inorganic cage with Si—O—Si frames and eight substituted organic tentacles. By creating a hydrophobic space and facilitating the distal segregation of polymer chains, POSS as a crosslinker produces a polymeric network capable of promoting salt dissociation and facilitating ion transport, thereby improving σ and the electrochemical performance of the resulting SPE.

Structure 12 represents a poly(ethylene oxide)-based (such as poly(polypropylene oxide-ethylene oxide-polypropylene oxide (P(PO-EO-PO)) polymer chain with amino ends. The present invention develops a solid-state polymer electrolyte loaded with a lithium salt (preferably, LiFSI), the solid-state polymer electrolyte includes a poly(ethylene oxide)-based network structure with amino ends, the poly(ethylene oxide)-based network structure with amino ends and epoxy alkanes (such as POSS) form, for example, a POSS-networked poly(polypropylene oxide-ethylene oxide-polypropylene oxide (P(PO-EO-PO)) structure.

Furthermore, the present invention proposes structure 13 in the solid-state polymer electrolyte that has a structure formed by poly(vinylidene fluoride-co-hexafluoropropylene) (PVdF-HFP) chain, which is highly dielectric and capable of self-crosslinking within a network (structure 14). The interpenetration of poly(ethylene oxide)-based (such as P (PO-EO-PO)) and poly(vinylidene fluoride)-based polymer (such as PVdF-HFP) networks enables the synthesis of an IPNE that is particularly good at dissolving lithium salts, thereby achieving room-temperature ionic conductivity comparable to that of separator-supported LEs (SLEs) with sufficient mechanical strength to form a free-standing membrane. The resulting IPNE presented excellent Li⁺ transport properties and favorable interfacial contact with electrodes, resulting in LMBs with high energy density and stable charge-discharge characteristics.

In addition, the selection of appropriate lithium salts is considered a strategy to increase σ and enable the formation of a stable solid-electrolyte interphase (SEI) layer. LiFSI salt is a promising salt possessing an FSI⁻ anion with the ability to stabilize the SEI layer. In the LiFSI-induced SEI on Li-anodes, the uniform distribution of LiF, Li₂CO₃, Li₂O, LiOH, and sulfur compounds tended to eliminate space charge accumulation, enhance Li⁺ migration, and reduce electron tunneling.

A high concentration of LiFSI substantially increases the σ and t_{Li+} of the resulting electrolytes. In SPEs, FSI⁻ may aggregate to form a polymer-like ionic network capable of facilitating the migration of Li⁺. Thus, constructing an amorphous regime incorporating polymer-like FSI⁻ aggregates is considered an effective strategy to facilitate Li⁺ transport.

Therefore, in some embodiments of the present invention, the lithium salt is LiFSI, and the FSI⁻ anion aggregates in the poly(vinylidene fluoride)-based network structure to form a cluster.

FIG. 1 shows the structure of the networked-P(PO-EO-PO) (i.e., N—P(PO-EO-PO)), in which hydrophobic POSS cages act as hubs in networking the hydrophilic P(PO-EO-PO) chains and creating free space to accommodate a salt or other polymer chain (such as PVdF-HFP in this work). When dissolved in a solvent (DMAc, N, N-Dimethylacetamide) to blend with the N—P(PO-EO-PO), the PVdF-HFP chains interpenetrated deeply into the free space of the N—P(PO-EO-PO). The dielectric —CF₂-segments of the PVdF-HFP enabled the polymer chains to crosslink among themselves, thereby forming homogeneously interpenetrating polymeric networks of P(PO-EO-PO) and PVdF-HFP. FIG. 1a illustrates the self-crosslinking mechanism of the present invention, in which the PVdF-HFP chains are deprived of fluorine or hydrogen atoms by imposing a nucleophilic attack on the carbon backbone of the chains using a catalytic media (e.g., an alkaline compound) such that the chains are bridged via C—C coupling among the attacked carbon atoms to form a PVdF-HFP network. The amino ends of the P(PO-EO-PO) (structure 12) may create an alkalescent environment capable of catalyzing defluorination/dehydrogenation and the subsequent crosslinking of PVdF-HFP chains (FIG. 1a).

Therefore, optionally, the poly(vinylidene fluoride)-based polymer includes a plurality of poly(vinylidene fluoride-co-hexafluoropropylene) (PVdF-HFP) chains, and the PVdF-HFP chains may be cross-linked into a poly(vinylidene fluoride)-based network structure. In addition, the poly(vinylidene fluoride)-based network structure may be bridged via C—C coupling among the PVdF-HFP chains. Moreover, the lithium salt may be lithium bis(fluorosulfonyl)imide (LiFSI), and the FSI⁻ anion aggregates in the poly(vinylidene fluoride)-based network structure to form a cluster. Furthermore, the amino ends of the modified poly(ethylene oxide)-based polymer may create an alkalescent environment capable of catalyzing defluorination/dehydrogenation and the subsequent crosslinking of PVdF-HFP chains to form an interpenetrating network structure.

To elucidate the role of the N—P(PO-EO-PO) in inducing the crosslinking reaction of the PVdF-HFP, the inventor examines the outcomes from various combinations of the PVdF-HFP, POSS, P(PO-EO-PO), and N—P(PO-EO-PO) solutions (in DMAc). All of the aforementioned solutions are colorless and transparent prior to mixing. The PVdF-HFP solution does not change color when it is mixed with the POSS solution, whereas it turns light-yellow and dark-yellow when respectively mixed with P(PO-EO-PO) or N—P(PO-EO-PO) solutions. The yellowish appearance indicates that the amino functionalities of the P(PO-EO-PO) species proceed with their nucleophilic attack on the carbon backbone to detach fluorine and hydrogen atoms, leading to the crosslinking of PVdF-HFP chains. It is possible that the high-basicity secondary amines of N—P(PO-EO-PO) (derived through the interaction of amino ends with POSS) promote the defluorination/dehydrogenation and subsequent crosslinking of the PVdF-HFP chains, resulting in the dark-yellow color.

### Characterization of IPNE

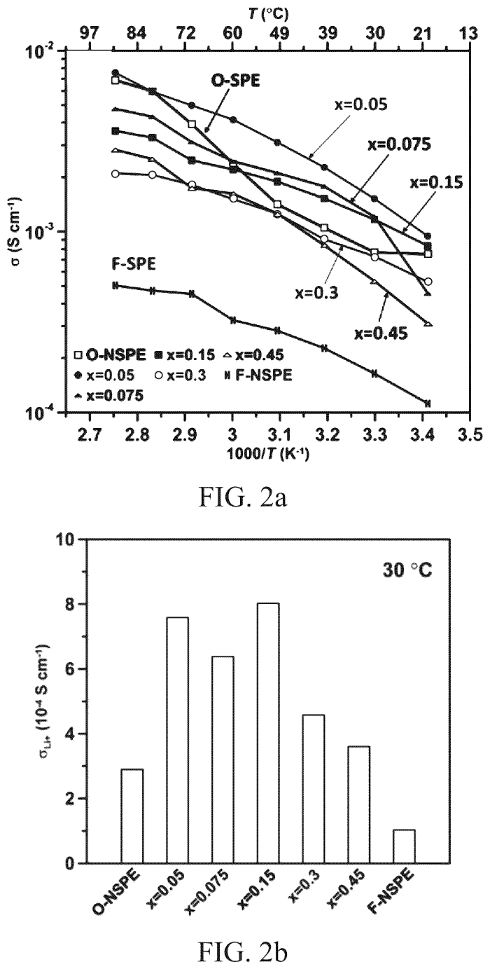

An N—P(PO-EO-PO)-based networked solid polymer electrolyte (O-NSPE) and a PVdF-HFP-based networked solid polymer electrolyte (F-NSPE) are respectively prepared by incorporating LiFSI salt within the N—P(PO-EO-PO) or PVdF-HFP. IPNEs are obtained by blending the O-NSPE and F-NSPE in DMAc at various F-NSPE/O-NSPE ratios followed by vacuum drying at 80° C. for 4 hours to ensure the complete removal of solvent. The IPNEs are referred to as FₓO-IPNE, where x represents the mass ratio of F-NSPE/O-NSPE. The O-NSPE, F-NSPE, and FₓO-IPNE samples formed as transparent and flexible membranes with a thickness of approximately 65 μm. FIG. 2a shows the ionic conductivities (o) of O-NSPE, F-NSPE, and FₓO-IPNE membranes at various temperatures within a range of 20-90° C. FIG. 2b shows Li⁺ conductivities (σ_{Li+}, which is equal to σ×t_{Li+}) of O-NSPE, F-NSPE, and FₓO-IPNE membranes at 30° C. The σ of the electrolyte membranes is measured via AC impedance analysis, wherein the membranes are inserted between two symmetric stainless steel (SS) foils to undergo testing across a temperature range of 20-90° C. FIG. 2a presents the variation in σ values of the electrolyte membranes as a function of temperature. The σ value of O-NSPE (with a networked polymer framework) exceeds that of F-NSPE. The FSI⁻ may have formed a polymer-like ionic network to facilitate Li⁺ transport, such that O-NSPE exhibits σ values higher than those of previously reported PEO-based SPEs containing other salts. The σ value of O-NSPE drops precipitously with a decrease in temperature, due to the extensive aggregation of FSI⁻ preventing the percolation of Li⁺ through the anion domain. The interpenetration of F-NSPE into O-NSPE improves the ionic conductivity of the resulting FₓO-IPNEs with x=0.05-0.15 in the vicinity of room temperature (e.g., 30° C.). This indicates that the —CF₂— linkage and —CF₃— pendant of the F-NSPE attracts FSI⁻ and help to segregate the FSI⁻ aggregates within the O-NSPE, thereby facilitating Li⁺ percolation through the FₓO-IPNEs. As shown in FIG. 2b, increasing the x value to above 0.15 led to a substantial σ decrease with the value of x. The observed a decrease in ionic conductivity with an increase in F-NSPE content (i.e., with a decrease in O-NSPE content), demonstrates the importance of the ether linkage in the O-NSPE on Lit transport via counter-ion pair dissociation and chain agitation. Among the electrolytes in FIG. 2a, F-NSPE exhibits the lowest ionic conductivity. In the application of FₓO-IPNEs, adjusting the F-NSPE/O-NSPE ratio to optimize the synergy between F-NSPE and O-NSPE is crucial.

The invention focuses on the performance of electrolytes at close to room temperature. Table 1 presents the ionic conductivity values of the electrolytes at 30° C. (from FIG. 2b).

TABLE 1

| electrolyte | σ (S cm⁻¹) | t_{Li+} |
|---|---|---|
| F-NSPE | 1.6 × 10⁻⁴ | 0.64 |
| F_{0.45}O-IPNE | 5.3 × 10⁻⁴ | 0.68 |
| F_{0.3}O-IPNE | 7.3 × 10⁻⁴ | 0.63 |
| F_{0.15}O-IPNE | 1.2 × 10−3 | 0.69 |
| F_{0.075}O-IPNE | 1.2 × 10−3 | 0.53 |
| F_{0.05}O-IPNE | 1.5 × 10−3 | 0.5 |
| O-NSPE | 7.7 × 10⁻⁴ | 0.38 |

O-NSPE and F-NSPE respectively exhibit ionic conductivities of 7.7×10⁻⁴ and 1.6×10⁻⁴ S cm⁻¹. The ionic conductivity of FₓO-IPNEs with x=0.05, 0.075, and 0.15 is at the 10⁻³ S cm⁻¹ level, which is comparable to that of a separator membrane swollen with conventional liquid electrolyte (e.g., Celgard 2500, FIG. S2). The inventor also analyzes the Li⁺ transference numbers (t_{Li+}) at 30° C., the results of which are listed in Table 1.

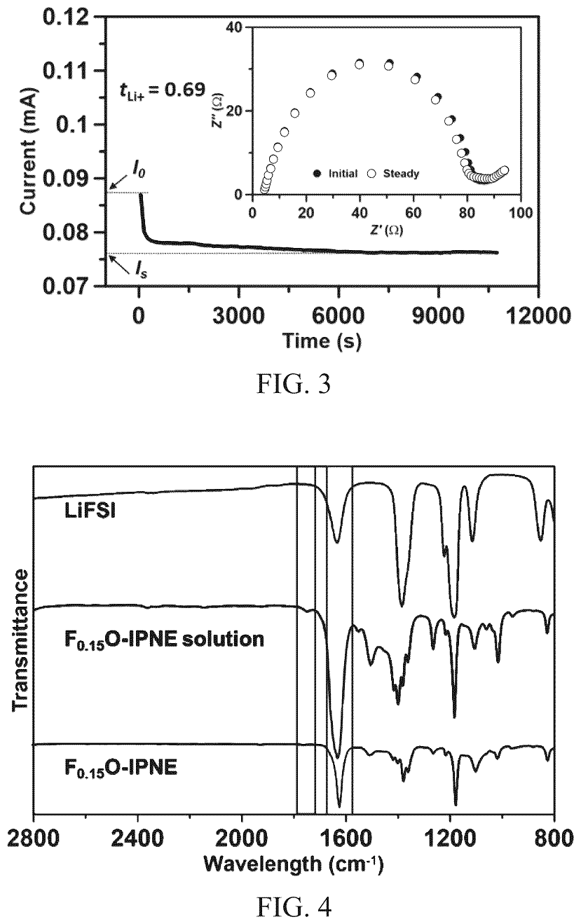

FIG. 3 presents the electrochemical analysis of F_{0.15}O-IPNE (as an example) showing the means by which the t_{Li+} values are derived. The t_{Li+} value of O-NSPE is 0.38; which slightly exceeded the values reported for PEO-based SPEs. This discrepancy may be attributed to our use of LiFSI salt and POSS crosslinker, which impeded anion transport. The incorporation of F-NSPE increases substantially with an increase in the value of t_{Li+}. The presence of F atoms in the PVdF-HFP may have weakened the interaction between Li⁺ and the polymer chains, due to the fact that F atoms (with valence charge of −1) on F-NSPE are less attractive to Li⁺ than O atoms (−2) on O-NSPE. Among the electrolytes, FₓO-IPNE exhibits the highest t_{Li+} value (0.69 at 30° C.). However, it does not exhibit the highest ionic conductivity. Lit conductivity (σ_{Li+}, equal to σ×t_{Li+}) governs the performance of LMBs. As shown in Table 1, σ_{Li+} varied as a function of x of FₓO-IPNE and F_{0.15}O-IPNE exhibited the highest σ_{Li+} of 8×10⁻⁴ S cm⁻¹ at 30° C. FIG. 2b illustrates the remarkable synergy between the functionalities of F-NSPE and O-NSPE generated via interpenetration, resulting in elevated σ_{Li+} values. In the following discussion, F_{0.15}O-IPNE is used to represent IPNE in subsequent analysis and application in LMBs.

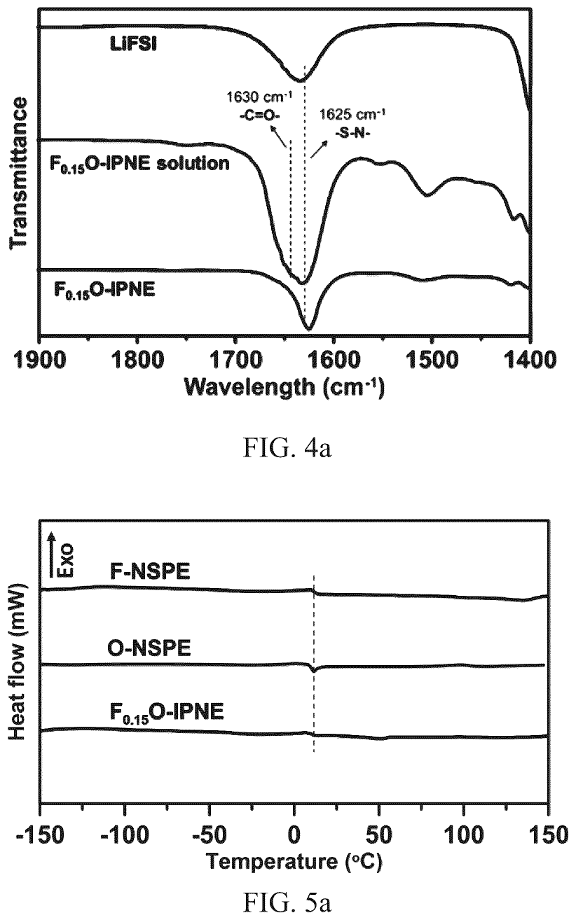

FTIR is used to assess the residual solvent (DMAc) content in the F_{0.15}O-IPNE. FIG. 4 presents the FTIR spectra of the F_{0.15}O-IPNE precursor solution (O-NSPE and F-NSPE blended in DMAc), F_{0.15}O-IPNE, and salt LiFSI. The major difference between the spectra of the F_{0.15}O-IPNE and its precursor solution is a broad absorption peak at approximately 1630 cm⁻¹ in the precursor solution. This peak may be attributed to the —C═O— band of DMAc at 1630 cm⁻¹ and the —S—N— band of LiFSI at 1625 cm⁻¹. FIG. 4a presents a comparison of the focused spectra in FIG. 4 in the proximity of 1630 cm⁻¹. The peak of the F_{0.15}O-IPNE precursor solution ranges between 1615 and 1645 cm⁻¹. The F_{0.15}O-IPNE membrane (obtained by vacuum drying the F_{0.15}O-IPNE precursor) exhibits a single —S—N— peak at 1625 cm⁻¹ similar to that exhibited in the LiFSI. The comparison in FIG. 4a indicates that vacuum-drying indeed removed the DMAc.

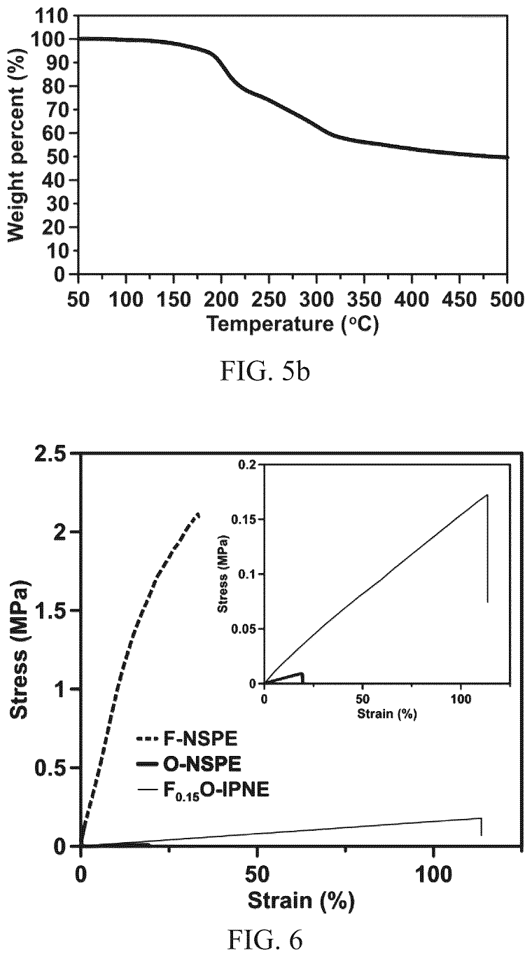

Differential scanning calorimetry (DSC) analysis of O-NSPE, F-NSPE, and F_{0.15}O-IPNE is conducted by heating the samples from −150 to 150° C. The DSC profiles in FIG. 5a indicates that the thermal responses of all the SPE are dominated by the solid-solid phase transition of the constituent LiFSI salt at 12° C. Essentially, the polymer framework of the SPEs is insensitive to the temperature scan, indicating that dispersal of the salt throughout the framework prevented the crystallization of polymer chains. The F_{0.15}O-IPNE sample presents a minor broadening of the melting transition peak at approximately 52° C., corresponding to the melting peak of PEO-based species. Note that the melting peak is not observed in O-NSPE, indicating that a small proportion of the P(PO-EO-PO) in F_{0.15}O-IPNE is not linked by the POSS, thereby allowing the partial crystallization of P(PO-EO-PO) chains. The infiltration of PVdF-HFP chains may have caused this minor flaw in the cross-linking of the P(PO-EO-PO). FIG. 5b presents thermogravimetric analysis profiles of F_{0.15}O-IPNE. The negligible weight loss at temperatures below 150° C. (<1%) indicates that the F_{0.15}O-IPNE contains only trace quantities of moisture. At temperatures of 150 to 200° C., the analysis reveals weight loss of roughly 9%, which has been attributed to the first step in the decomposition of LiFSI. The weight loss in the F_{0.15}O-IPNE membrane increases substantially at temperatures above 200° C., probably due to the decomposition of LiFSI and non-crosslinked P(PO-EO-PO) through the interaction of Li⁺ with oxygen atoms, which weakens the C—O bonds. Nevertheless, these results demonstrate the thermal durability of F_{0.15}O-IPNE is sufficient for application in LMBs.

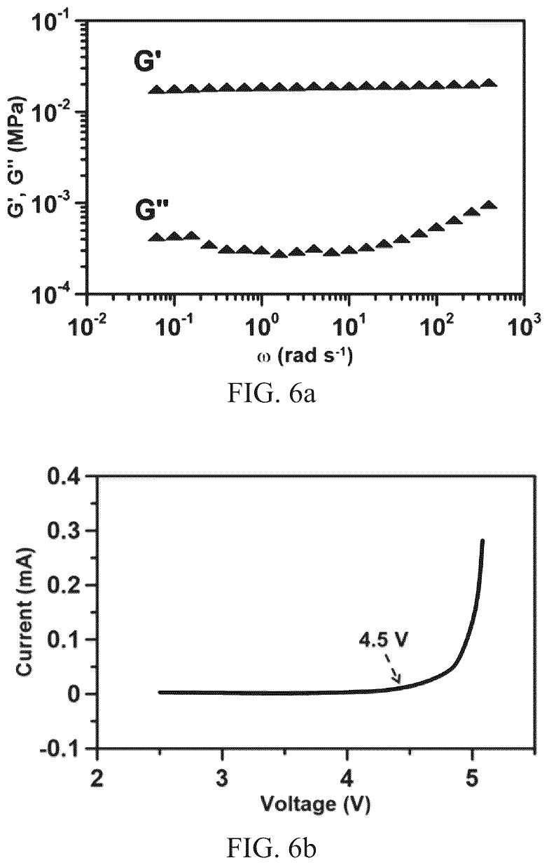

The mechanical properties of solid polymer electrolytes are critical to maintaining a stable interface during swift Li plating-stripping, which could otherwise result in a drastic change in the volume of the Li anode. As shown in FIG. 6, O-NSPE exhibits poor resistance to mechanical stress, whereas F-NSPE is able to withstand considerable stress but exhibits poor resistance to high strain. Following the interpenetration of O-NSPE and N-NSPE, the mechanical strength of F_{0.15}O-IPNE increases considerably (beyond that of O-NSPE) as did the elongation strain (beyond that of O-NSPE and F-NSPE). The interpenetration of the two polymers strengthens the O-NSPE and relieves the stiffness of F-NSPE, resulting in F_{0.15}O-IPNE samples with mechanical characteristics suitable for use as an SPE in LMBs. To demonstrate the mechanical behavior as a solid-state matter, the F_{0.15}O-IPNE membrane is subjected to oscillatory rheology analysis. The inventor evaluates the frequency-dependent viscoelastic moduli; i.e., the storage modulus (G′) and loss modulus (G″) respectively corresponding to the elastic and viscous contributions. As shown in FIG. 6a, the G′ value is more than an order of magnitude higher than the G″ over the entire frequency range, reflecting the solid-state character of the F_{0.15}O-IPNE membrane. The high elasticity of the F_{0.15}O-IPNE should enhance tolerance for changes in volume induced by high-capacity Li plating and stripping.

FIG. 6b presents the linear sweep voltammetry profile of a Li|F_{0.15}O-IPNE|SS cell to assess the electrochemical stability of F_{0.15}O-IPNE. The anodic voltage scan at 0.5 mV s⁻¹ beginning at an open-circuit potential of 2.5 V reveals a flat profile up to the appearance of an oxidation peak at 4.5 V (vs. Li/Li⁺), indicating that the F_{0.15}O-IPNE membrane is compliant with high voltage cathodes used in batteries with a high energy density.

The ion transport in polymer-in-salt electrolytes (lithium salt content exceeding 50 wt % of the polymer) is associated with the decoupled ion conduction mechanism, wherein Li⁺ transport is decoupled with the polymer chain motion but facilitated by clustered anions, resulting in a high (Lit. As mentioned previously, FSI⁻ anions tend to aggregate into polymer-like domains, which contributes to the high/Li⁺ observed in the present study. The mechanism underlying the decoupled ion conduction may have governed Li⁺ conduction in the F_{0.15}O-IPNE.

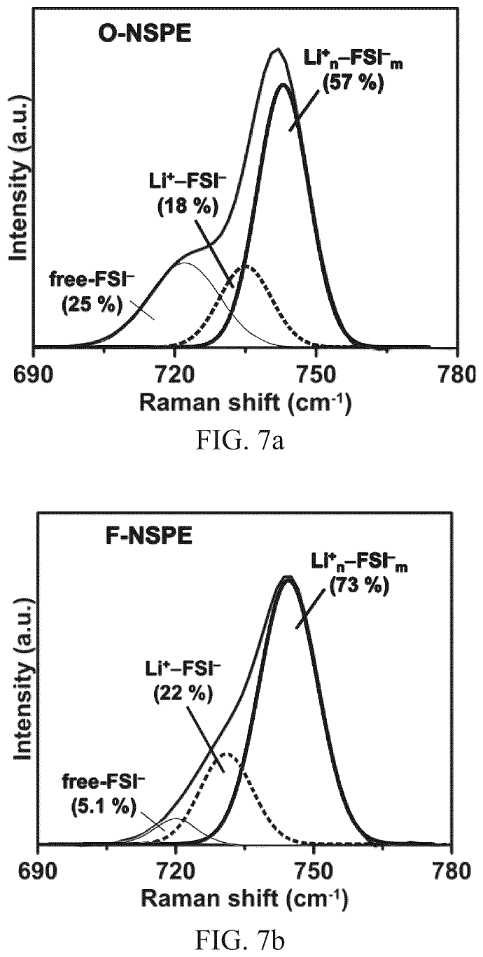

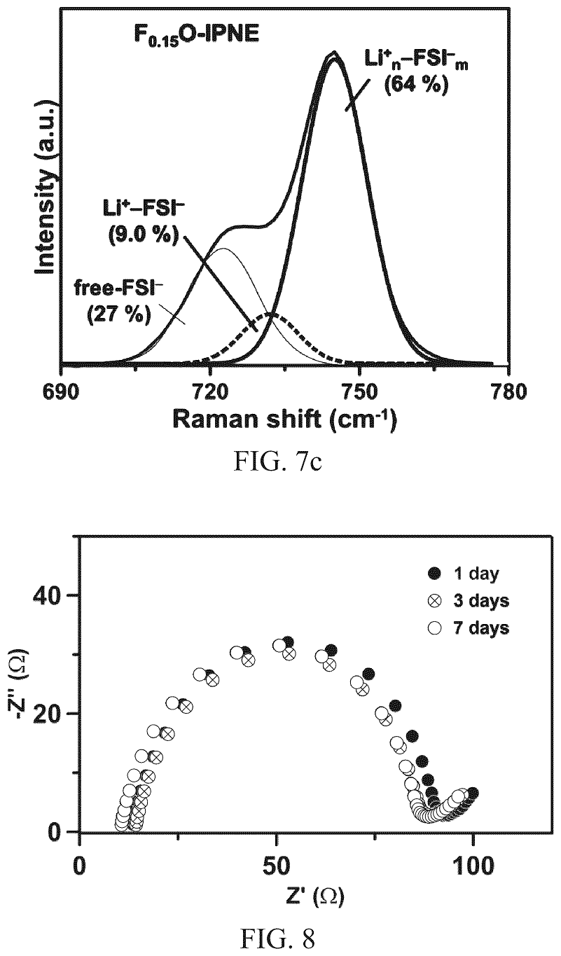

Raman spectroscopy is used to clarify the mechanism involved in ion conduction by identifying the three FSI⁻ states exhibiting different S—N—S stretching vibration modes over a wavelength range of 700-800 cm⁻¹. The three states include free-FSI⁻ (720 cm⁻¹), Li⁺-FSI⁻ (732-735 cm⁻¹), and complexed Li+ₙ-FSI⁻ₘ (745 cm⁻¹) states. FIG. 7a-7c respectively present the Raman spectra of O-NSPE, F-NSPE, and F_{0.15}O-IPNE. A comparison of the spectra of O-NSPE and F-NSPE reveals that the —C—O—C-units of O-NSPE facilitate the dissociation of ion pairs, resulting in a high proportion of the free-FSI⁻ state (25%). The —CF₂—/—CF₃ units of the F-NSPE interact with FSI⁻ to aggregate anions, resulting in a high proportion of the complexed Li⁺ₙ-FSI⁻ₘ state (73%). However, the tangled polymer chains exhibit poor ion-pair dissociating ability (low in the free-FSI⁻ state and high in the Li⁺-FSI⁻ state). Ion-pair dissociation in O-NSPE facilitates ion transport, resulting in the ionic conductivity of O-NSPE exceeding that of F-NSPE (Table 1). Nevertheless, the formation of polymer-like FSI⁻ aggregates results in the t_{Li+} of F-NSPE exceeding that of O-NSPE. Following the mutual interpenetration of the O-NSPE and F-NSPE networks, the resulting F_{0.15}O-IPNE presents a high proportion of free-FSI⁻ state (27%), due to cross-linking of the PVdF-HFP chains and their incorporation with the —C—O—C— chains of the O-NSPE to form a framework with a high dissociation ability. The free-FSI⁻ state behaves like the empty orbitals of the conduction band in semiconductors providing pathways for Li⁺ transport. The F_{0.15}O-IPNE possess a low proportion of the Li⁺-FSI⁻ state (9.0%), wherein 91% of the Li⁺ cations are capable of traveling within the polymer-like FSI⁻ domains (uniformly distributed due to the segregation of PVdF-HFP chains by P(PO-EO-PO) in the F_{0.15}O-IPNE) to facilitate Li⁺ percolation. The high proportion of mobile Li⁺ and speedy transport pathways explains the high Li⁺ conductivity of the F_{0.15}O-IPNE.

### Interfacial Compatibility Between IPNE and Li

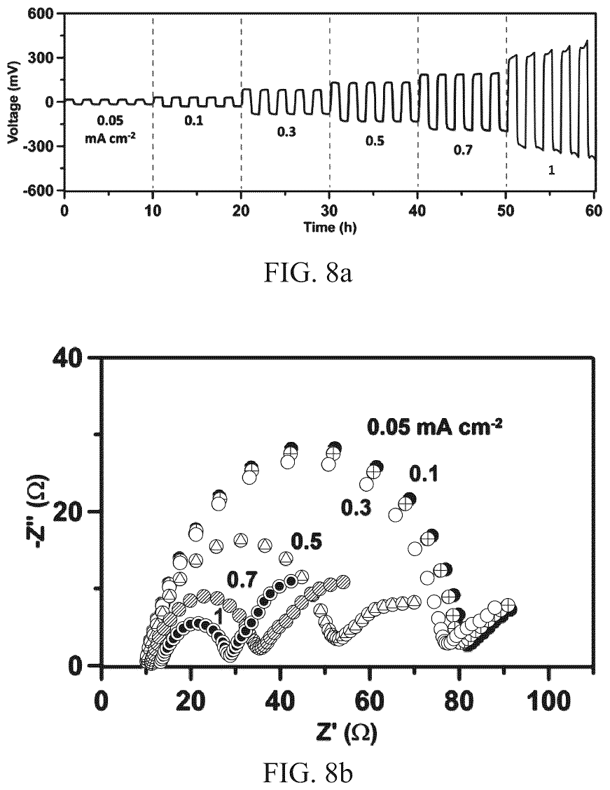

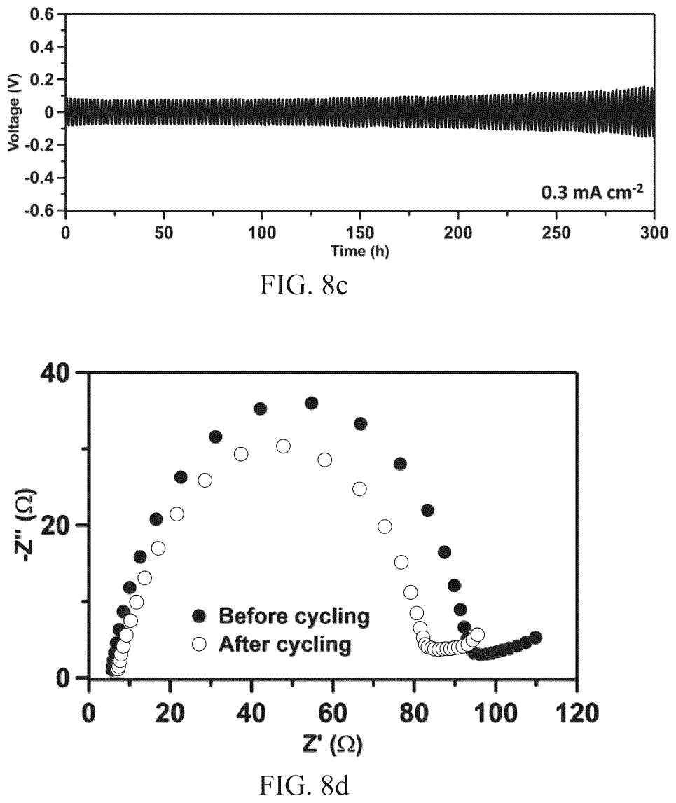

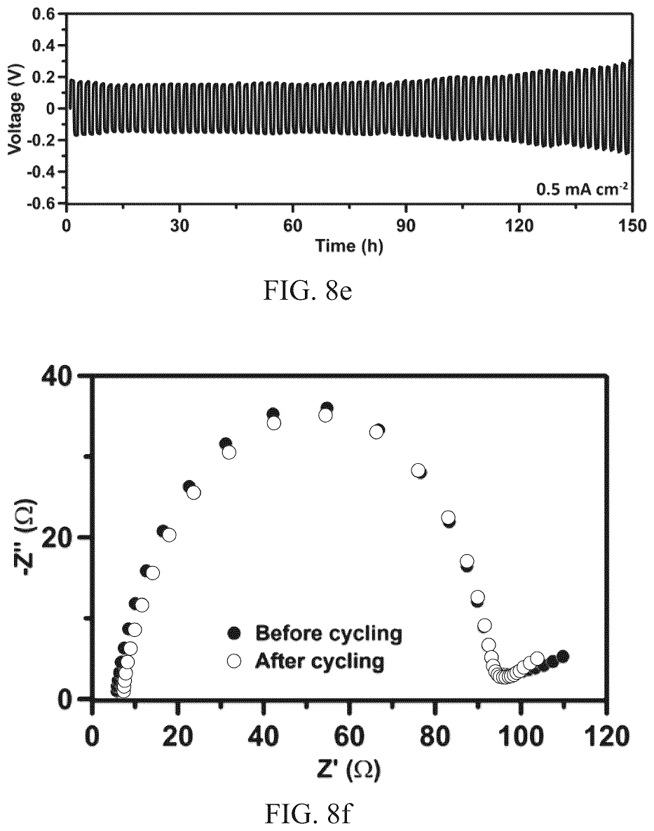

The stability of the interface between the Li anode and SPE can have a profound influence on the electrochemical performance of LMBs. The inventor conducts a preliminary assessment of interface conditions by analyzing a Li|F_{0.15}O-IPNE|Li cell using AC impedance spectroscopy at the open-circuit potential as a function of storage time at 30° ° C. As shown in FIG. 8, there is little variation in the interfacial resistance of the cell throughout the 7-day storage period, indicating that the occurrence of spontaneous side reactions at the interface could be disregarded. The interfacial stability of Li|F_{0.15}O-IPNE|Li is further assessed via galvanostatic plating-stripping at 30° C., with the current density varied between 0.05 and 1 mA cm⁻² and each plating or stripping period lasting for 1 hour. As shown in FIG. 8a, the Li plating-stripping profiles of the Li|Li cell remain smooth even under a high current density of 1 mA cm⁻², which is an unusually high value for solid-state electrolytes. FIG. 8b presents the impedance spectra obtained during the interval between two neighboring galvanostatic plating-stripping stages. The spectra present a gradual decrease in interfacial resistance, indicating that the F_{0.15}O-IPNE adapted to improve contact with the Li surface during cycling. The excellent interfacial contact with Li metal, along with the high σ_{Li+} of the F_{0.15}O-IPNE, is advantageous in suppressing Li-dendrite growth in long-term cycling.

FIG. 8c presents the plating-stripping cycling results with under a current density of 0.3 mA cm⁻² the charge/discharge capacity fixed at 0.3 mAh cm⁻². During long-term cycling (300 h), the profile presents a stable voltage plateau with a slight increase in polarization voltage indicating a durable F_{0.15}O-IPNE solid-state interface. As shown in FIG. 8d, the impedance spectra present a slight decrease in interfacial resistance after cycling. Thus, the gradual increase in polarization voltage with the number of cycles (FIG. 5c) can be attributed to the increasing oscillation hindrance of the F_{0.15}O-IPNE membrane between the two Li-electrodes alternately expanding and contracting their volumes during cycling. Plating-stripping cycling is also performed at 0.5 mA cm⁻² with the charge/discharge capacity fixed at 0.5 mAh cm⁻². As shown in FIG. 8e, the increase in polarization with cycling is more pronounced under a higher deposition current (0.5 vs. 0.3 mA cm⁻²). As shown in FIG. 8f, the interfacial resistance of the cell remained nearly unchanged after cycling at 0.5 mA cm⁻². The results in FIG. 8a-d supports the assertion that the increase in polarization during cycling can be attributed to an increase in resistance associated with the movement of F_{0.15}O-IPNE in the cell, rather than from a deterioration of the Li-electrolyte interface. In general, the Li plating-stripping results indicate that the F_{0.15}O-IPNE tolerated huge changes in the volume of Li without losing contact at the interface.

### Electrochemical Performance of Solid-State LMBs

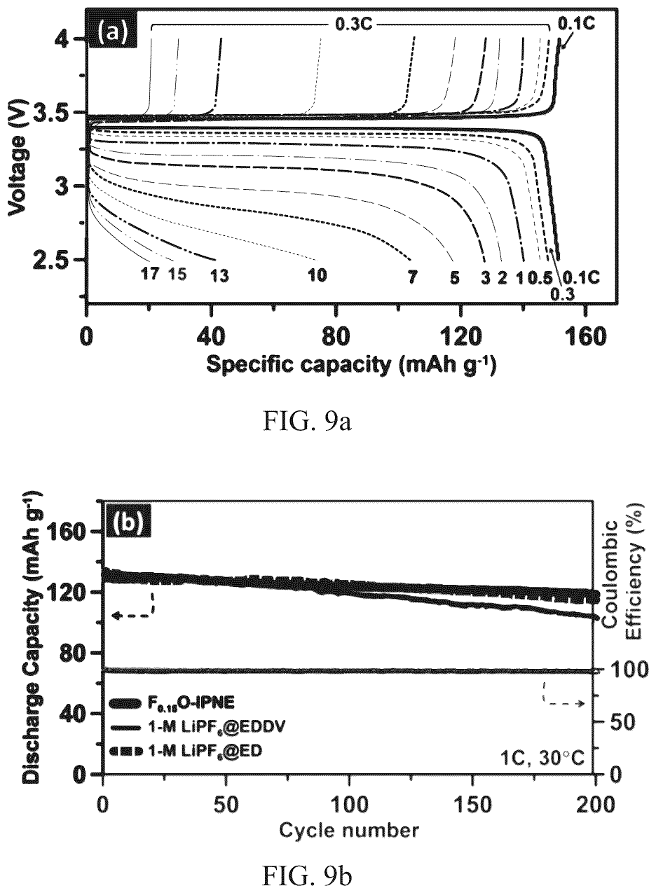

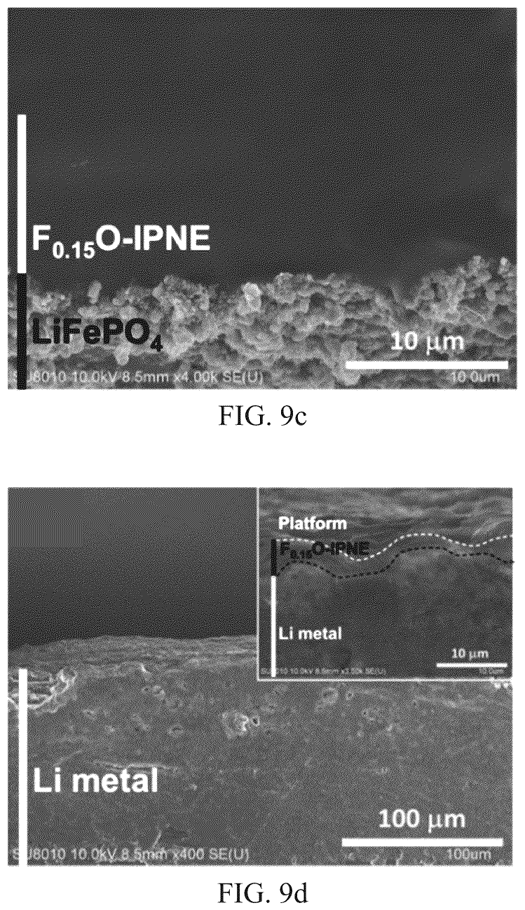

The F_{0.15}O-IPNE membrane is incorporated in a Li|LiFePO₄ battery to investigate its performance in LMBs. The loading of active LiFePO₄ in the cathode is 2.5 mg cm⁻². FIG. 9a presents charge-discharge profiles of the Li|F_{0.15}O-IPNE|LiFePO₄ battery, in which the first charge-discharge cycle is performed at 0.1 C and followed by charging at 0.3 C and discharging at various C-rates within a voltage range of 2.5-4.0 V. In general, the battery delivers a high discharge capacity of 151-104 mAh g⁻¹ at 0.1-7 C. The battery also withstands a high discharge rate of 17 C, corresponding to a current density of approximately 7 mA cm⁻².

The Li|F_{0.15}O-IPNE|LiFePO₄ battery is also subjected to long-term cycling at a current of 1 C. As shown in FIG. 9b, the Li|F_{0.15}O-IPNE|LiFePO₄ battery initially presents a specific discharge capacity of 132 mAh g⁻¹ and retained 90% of its capacity after 200 cycles, with the coulombic efficiency remaining at close to 100% throughout the entire cycling test. By contrast, the cycling stability and coulombic efficiency of Li|LiFePO₄ batteries assembled using two liquid electrolytes are not as good. Note that the liquid electrolytes are 1-M LiPF₆@EDDV and 1-M LiPF₆@ED, respectively corresponding to 1-M LiPF₆ in ethylene carbonate (EC)-diethyl carbonate (DEC)-dimethyl carbonate with 1 vol % vinylene carbonate and 1-M LiPF₆ in EC-DEC. FIG. 9c presents an SEM image of the tight contact between the F_{0.15}O-IPNE and LiFePO₄ particles. In preparing the cathode, the inclusion of F_{0.15}O-IPNE in the binder keeps the LiFePO₄ particles in intimate contact with the F_{0.15}O-IPNE, thereby facilitating unobstructed Li⁺ transport throughout the battery.

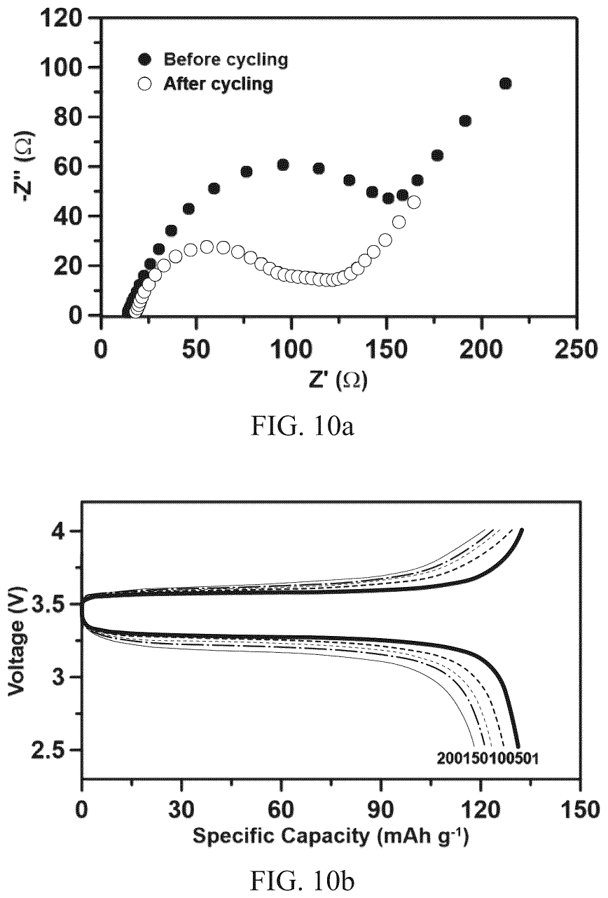

FIG. 10a presents the impedance spectra of the Li|F_{0.15}O-IPNE|LiFePO₄ battery (in FIG. 9b) measured before and after 200 charge-discharge cycles. The charge transfer resistance of the battery decreases after cycling, due to the fact that the F_{0.15}O-IPNE adapted itself to enhance compatibility with the Li anode. Note that a similar phenomenon is observed in the cycling of the symmetric Li|Li cell (FIG. 8b, 8d). FIG. 10b presents charge-discharge profiles of the Li|F_{0.15}O-IPNE|LiFePO₄ battery as a function of cycle number. Here, it sees only a slight cycling-induced increase in polarization, demonstrating the high stability of the F_{0.15}O-IPNE.

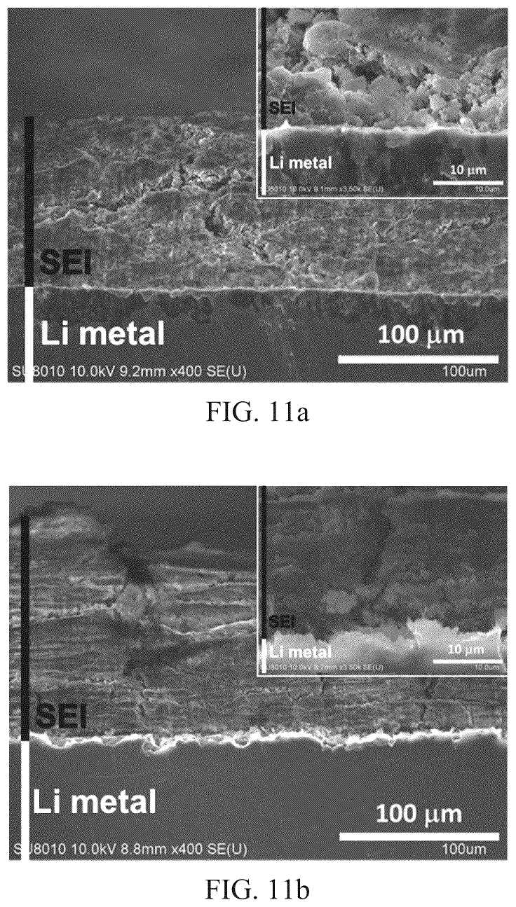

It appears that structural changes in the surface of the Li-anode may be the primary factor affecting cycling performance. As shown in FIG. 9b, SEM is used to observe changes in the morphology of the SEI-layer after 200 charge-discharge cycles. FIG. 9d presents a side-view image showing the surface of the Li-anode in the cycled Li|F_{0.15}O-IPNE|LiFePO₄. After peeling off the F_{0.15}O-IPNE electrolyte, the Li-anode surface exhibits a dense uniform deposit of metallic Li. The magnified image of the interface (inset in FIG. 9d) shows a thin F_{0.15}O-IPNE interlayer on the Li film featuring a wavy topography indicative of homogeneous Li deposition due to large Li nucleation size. The uniform deposition is attributed to the localization of FSI⁻ anions, which prevents the formation of a space-charge zone on the Li surface and suppresses Li-dendrite growth. As shown in FIGS. 11a and 11b, the surface of the Li-anode in the cycled Li|LE|LiFePO₄ batteries (using 1-M LiPF₆@EDDV or 1-M LiPF₆@ED) exhibits a thick SEI layer (˜100 μm) with indents and cracks in the deposited Li film. Note that these imperfections are expected to deplete the inventories of electrolytes and Li with a corresponding negative effect on capacity.

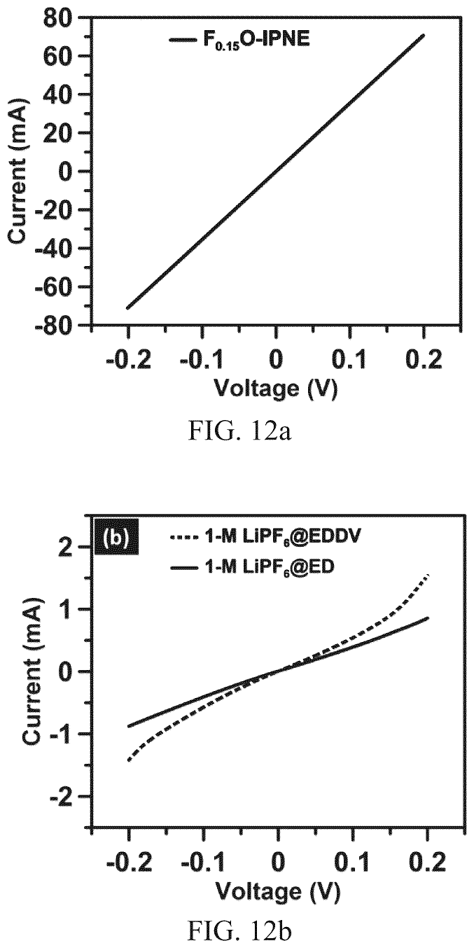

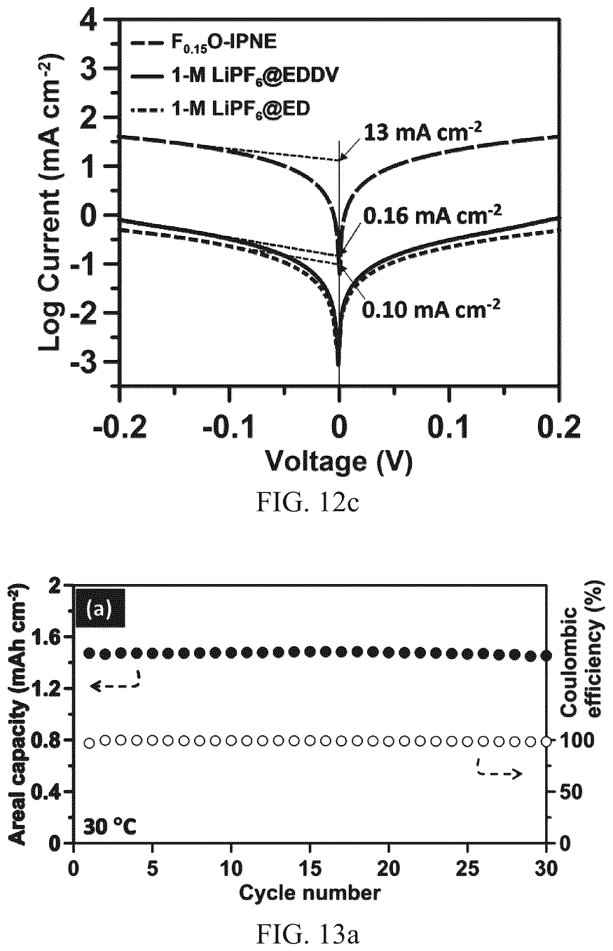

The inventor seeks to elucidate the performance of F_{0.15}O-IPNE relative to that of the two LEs in the Li∥LiFePO₄ batteries by analyzing the Li⁺ transfer kinetics in symmetric Li∥Li cells subjected to potentiostatic current-voltage polarization with scanning from −0.2 to 0.2 V (vs. Li/Li⁺) at 1 mV s⁻¹. The current induced from the voltage scan corresponds to the rate of Li⁺ transfer (in Li plating-stripping) at the electrode interface. As shown in FIGS. 12a and 12b, the Li plating-stripping rate of the F_{0.15}O-IPNE cell exceeds that of the other two LE cells by more than one order of magnitude. FIG. 12c presents Tafel plots of the Li∥Li cells with the various electrolytes. The exchange current density (i₀) obtained from the F_{0.15}O-IPNE cell is 13 mA cm⁻², which substantially exceeds those of the cells with 1-M LiPF₆@EDDV (0.16 mA cm⁻²) or 1-M LiPF₆@ED (0.10 mA cm⁻²). The high Lit-transfer rate at the interface probably is attributed to the absence of a thick SEI at the interface between the FₓO-IPNE and Li-anodes.

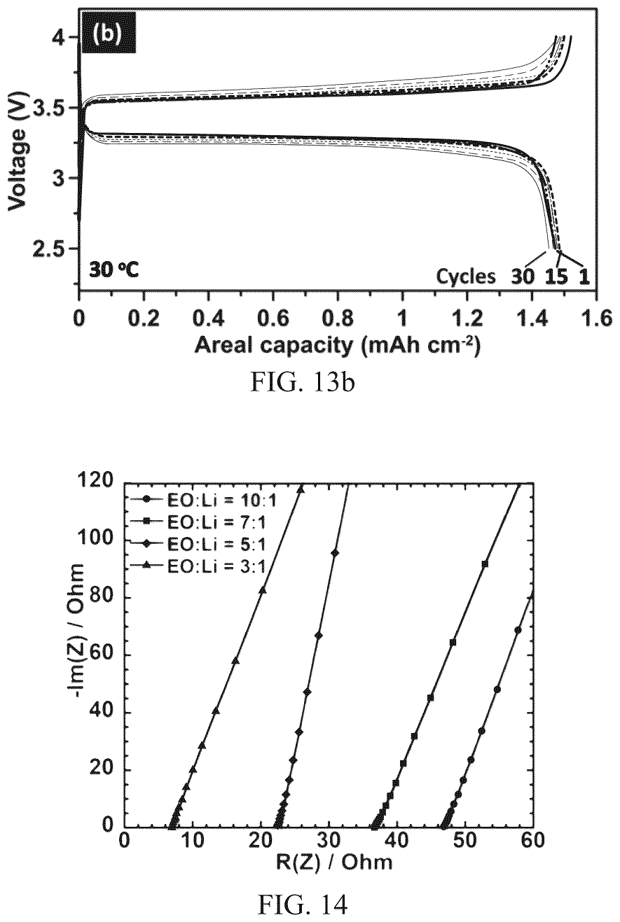

FIG. 13a illustrates the cycling performance of Li|F_{0.15}O-IPNE|LiFePO₄ battery with high loading of active LiFePO₄ (10.6 mg cm⁻²). The areal capacity of Li|F_{0.15}O-IPNE|LiFePO₄ battery is 1.48 mAh cm⁻² at a current density of 0.3 mA cm⁻², remaining nearly unchanged through 30 cycles. FIG. 13b presents the corresponding charge-discharge profiles of Li|F_{0.15}O-IPNE|LiFePO₄ as a function of the number of cycles. The inventor observes a slight increase in polarization during the cycling test. These results demonstrate the benefits of FₓO-IPNE, which can tolerate enormous changes in volume, while providing a stable interfacial contact. The areal capacity of FₓO-IPNE indicates the feasibility of its application in solid-state LMBs.

Furthermore, the inventor focuses on enhancing the concentration of lithium salt in solid polymer electrolytes (SPEs) and exploring the dissolution and dissociation of lithium salt in polymers. The lack of free Li⁺ ions in SPEs impedes the transfer of Li⁺ ions, making it challenging to achieve high ionic conductivity. Polymer-in-salt electrolytes, which have high salt concentrations, generally exhibit higher conductivities than conventional SPEs. However, they are accompanied by a significant deterioration of mechanical properties.

The polymer electrolytes of the invention have excellent solubility and dissociation of lithium salt, making it well-suited for creating high-salt concentration electrolytes. The interpenetrating polymer network electrolyte (IPNE) with a synergistic effect can result in the highest conductivity and best mechanical properties. Table 2 and FIG. 14 show the ionic conductivity of the electrolytes with different EO:Li ratios. The electrolyte contained high salt concentration (EO:Li=3:1), in which anions aggregate to form polymer-like domains to facilitate Li⁺ diffusion. Furthermore, the anions are localized in the aggregate, and the formation of a space-charge zone is prevented, which leads to uniform Li deposition on the Li-anode surface. The invention is a promising strategy for developing SPEs that are appropriate for use in lithium metal batteries.

TABLE 2

| | Resistance | Thickness | Ionic conductivity |
|---|---|---|---|
| Sample | (Ohms) | (μm) | (S cm⁻¹) |
| EO:Li = 10:1 | 46.9 | 410 | 4.94 × 10−4 |
| EO:Li = 7:1 | 36.8 | 350 | 5.38 × 10−4 |
| EO:Li = 5:1 | 22.6 | 310 | 7.77 × 10−4 |
| EO:Li = 3:1 | 7.04 | 260 | 2.1 × 10−3 |

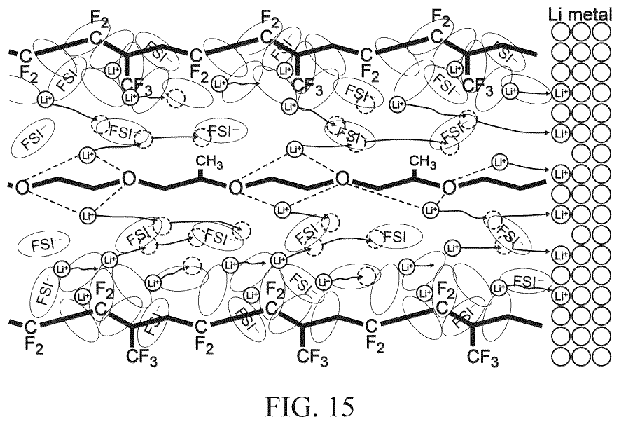

FIG. 15 shows a schematic diagram of the facile transport of Lit in FₓO-IPNE. The pathways of Li⁺ transport in FₓO-IPNE electrolyte may be: (1) Li⁺ hopping on agitating P(PO-EO-PO) chains; and (2) Li⁺ transport among vacant sites (i.e., free-FSI⁻ in FSI⁻-aggregates, namely, decoupled ion conduction. It appears that the P(PO-EO-PO) dissociates Li⁺-FSI⁻ pairs to increase the number of free-FSI⁻ sites, thereby promoting Li⁺ transport. The formation of FSI⁻-aggregates in the FₓO-IPNE suppresses the formation of the space-charge zone on the Li-anode surface, resulting in uniform Li-deposition.

The polymer-like FSI⁻ aggregates are homogeneously distributed over the —CF₂—/—CF₃— segments of the PVdF-HFP network when interpenetrated with P(PO-EO-PO). The FSI⁻ aggregates provide a pathway for Li⁺ shuttling between two electrodes, while the FSI⁻ ions are less mobile, resulting in a high t_{Li+} value. The improved connection of the aggregate domains in the PVdF-HFP network facilitates the percolation of Li⁺. The Li⁺ transport rate depends on the availability of vacant sites in the FSI⁻ aggregate for Li⁺ diffusion or hopping. Raman analysis reveals that the vacant sites corresponded to free-FSI⁻ (FIG. 7). The —C—O—C— linkages on agitating P(PO-EO-PO) chains attract Li⁺ (for hopping transport on the chains) and dissociate Li⁺-FSI⁻ pairs to increase the number of free-FSI⁻ sites, thereby facilitating Li⁺ transport through the FSI⁻-aggregate pathway, namely, decoupled ion conduction. The high t_{Li+} value of the FₓO-IPNE indicates that the FSI⁻-aggregate pathway governs the transport of Li⁺ and contributes to the high stability of the resulting LMB by suppressing the formation of the space-charge zone on the Li-anode surface.

The qualities of FₓO-IPNE electrolytes can be further optimized by using some strategies below. Substituting new cross-linker to provide distinctive properties for IPNE membrane, which can meet further requirements for practical implementation in high energy, durable, and good safety solid-state LMBs. Another strategy is incorporating ceramic into IPNE electrolyte to construct composite polymer electrolyte (CPE). Such CPE exhibits improved compatibility and stability against the lithium metal anode. Furthermore, the CPE used in solid-state Li|LiFePO₄ cells delivers stable cycling performance at room temperature These structural design for SPEs represents a promising way for high-performance solid-state LMBs.

The present invention synthesizes an interpenetrating polymer network electrolyte, for example, FₓO-IPNE, which exploits the synergistic effects of O-based P(PO-EO-PO) (i.e., O-NSPE) and F-based PVdF-HFP (i.e., F-NSPE) networks. Pre-networked P(PO-EO-PO) induces the networking of incorporated PVdF-HFP chains, resulting in connected Li⁺ transport pathways in FₓO-IPNE. The FₓO-IPNE contains salt LiFSI, in which FSI⁻ anions aggregate to form polymer-like domains to facilitate Li⁺ diffusion. The resulting PVdF-HFP network results in the formation of homogeneously distributed and connects FSI⁻-aggregate domains conducive to the percolation of Lit, whereas the P(PO-EO-PO) network attracts Li⁺ to create vacant sites in the FSI⁻-aggregate domains to facilitate Li⁺ transport among the connected domains. Under this Lit-transport pattern, the FₓO-IPNE exhibits high ionic conductivity (approximately 1 mS cm⁻¹) and high t_{Li+} (0.69) at 30° C. The fact that the FSI⁻ anions are localized in the aggregate prevents the formation of a space-charge zone resulting in uniform Li deposition on the surface of the Li-anode. When assembled into a symmetric Li∥Li cell, the FₓO-IPNE presents an exchange current density of 13 mA cm 2, which substantially exceeds those of the cells using liquid electrolytes. The LMB of Li|FₓO-IPNE|LiFePO₄ presents charge-discharge cycling performance superior to that of LMBs assembled using liquid electrolytes and reached a high discharge rate of 7 mA cm⁻². The invention demonstrates that creating an anion-aggregate domain for Li⁺ transport while exploiting the synergistic relationship between polymeric networks is a promising strategy for developing SPEs suitable for LMBs.

What is claimed is:

1. A solid-state polymer electrolyte for a lithium battery, comprising:
a solid-state network polymer electrolyte formed by a modified poly(ethylene oxide)-based polymer and an epoxy alkane crosslinker to form a poly(ethylene oxide)-based network structure, wherein the modified poly(ethylene oxide)-based polymer has an amino end, wherein the solid-state network polymer electrolyte comprises a lithium salt, and a ratio of EO group to Li⁺ in the solid-state network polymer electrolyte ranges from 1:1 to 3:1, wherein the solid-state network polymer electrolyte is interpenetrated by a poly(vinylidene fluoride)-based polymer.

2. The solid-state polymer electrolyte according to claim 1, wherein the epoxy alkane crosslinker selected at least one of siloxane, trimethylolpropane triglycidyl ether (TMPTGE), and polydimethylsiloxane dioxirane.

3. The solid-state polymer electrolyte according to claim 1, wherein the poly(vinylidene fluoride)-based polymer comprises a plurality of poly(vinylidene fluoride-co-hexafluoropropylene) (PVdF-HFP) chains, and the PVdF-HFP chains are cross-linked into a poly(vinylidene fluoride)-based network structure.

4. The solid-state polymer electrolyte according to claim 3, wherein the poly(vinylidene fluoride)-based network structure is bridged via C—C coupling among the PVdF-HFP chains.

5. The solid-state polymer electrolyte according to claim 3, wherein the lithium salt is lithium bis(fluorosulfonyl)imide (LiFSI), and the FSI⁻ anion aggregates in the poly(vinylidene fluoride)-based network structure to form a cluster.

6. The solid-state polymer electrolyte according to claim 3, wherein the amino ends of the modified poly(ethylene oxide)-based polymer create an alkalescent environment capable of catalyzing defluorination/dehydrogenation and the subsequent crosslinking of PVdF-HFP chains to form an interpenetrating network structure.

7. The solid-state polymer electrolyte according to claim 1, wherein the solid-state network polymer electrolyte further comprises a filler, wherein the filler is a lithium lanthanum zirconium oxide (LLZO) ceramic filler.

8. The solid-state polymer electrolyte according to claim 1, wherein the solid-state network polymer electrolyte comprises a network structure formed by cross-linking polyhedral oligomeric silsesquioxane (POSS) with the modified poly(ethylene oxide)-based polymer.

9. A solid-state polymer electrolyte for a lithium battery, comprising:
an interpenetrating network structure, wherein the interpenetrating network structure comprises a poly(ethylene oxide)-based network structure and a poly(vinylidene fluoride)-based network structure, wherein the poly(ethylene oxide)-based network structure is formed by a modified poly(ethylene oxide)-based polymer material and an epoxy alkane crosslinker, and the modified poly(ethylene oxide)-based polymer has an amino end, the poly(vinylidene fluoride)-based network structure is formed by cross-linking a plurality of poly(vinylidene fluoride-co-hexafluoropropylene) (PVdF-HFP) chains, and the poly(vinylidene fluoride)-based network structure has FSI⁻ anions aggregated to form FSI⁻ anionic clusters.

10. The solid-state polymer electrolyte according to claim 9, wherein a ratio of EO group to Li⁺ in the interpenetrating network structure ranges from 1:1 to 3:1.

11. The solid-state polymer electrolyte according to claim 9, wherein the epoxy alkane crosslinker selected at least one of siloxane, trimethylolpropane triglycidyl ether (TMPTGE), and polydimethylsiloxane dioxirane.

12. The solid-state polymer electrolyte according to claim 9, wherein the poly(vinylidene fluoride)-based network structure is bridged via C—C coupling among the PVdF-HFP chains.

13. The solid-state polymer electrolyte according to claim 9, wherein the amino ends of the modified poly(ethylene oxide)-based polymer create an alkalescent environment capable of catalyzing defluorination/dehydrogenation and the subsequent crosslinking of PVdF-HFP chains to form an interpenetrating network structure.

14. The solid-state polymer electrolyte according to claim 9, further comprising a filler, wherein the filler is a lithium lanthanum zirconium oxide (LLZO) ceramic filler.
